(19) United States
(12) Patent Application Publication
(10) Pub. No.: US 2008/0307149 A1
(43) Pub. Date: Dec. 11, 2008

(54) Clustering System and Flexible Interconnection Architecture Thereof

(76) Inventors: Tomonori Hirai, Fremont, CA (US); Jyh Ming Jong, Fremont, CA (US)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/760,068

(22) Filed: Jun. 8, 2007

(51) Int. Cl. G06F 13/40

(52) U.S. Cl. 710/316

(57) ABSTRACT

An interconnection architecture is provided for flexibly connecting a primary host module or an added host module to a network switch in a clustering system. The interconnection architecture mainly includes plural first slots, a primary function module, an added function module and plural multifunctional buses. The first slots electrically connect the network switch with the primary and added host modules. The primary function module inserts in one of the first slots to electrically connect the primary host module with the network switch; and the added function module inserts in one of the first slots to electrically connect the added host module with the network switch. The multifunctional buses connect the network switch with the first slots and also connect the first slots with the primary host module and the added host module.

### BACKGROUND OF THE INVENTION

1. Field of Invention

The present invention relates to an interconnection architecture of a computing system, and more particularly to multifunctional interconnections that facilitates multiple types of communication in a clustering system.

2. Related Art

Generally, in a typical clustering system, a connection slot for a specific module can only be used for similar function. For example, computation slot is dedicated for the use of computation, such as the use of connecting computation nodes; I/O (Input/Output) slot is only used for various I/O devices. To support different function, different dedicated slots need to be provided for those functions in the clustering system.

FIG. 1 shows a typical implementation of a clustering computer in the prior art. The drawing specifically shows logical connections for computation and storage. The clustering system mainly includes compute nodes 110˜120, network-attached storage devices 130˜140, NICs Network Interface Controllers) 162˜164, and network switch 180. The compute nodes 110˜120 are standalone computer systems that have an operating system domain. Each of the compute nodes 110˜120 uses one or more system I/O (Input/Output) bus 150 to connect with various I/O devices. The compute nodes 110˜120 also connect to the NICs 162˜164 through the system I/O buses 150. Through the network interfaces 170, the NICs 162˜164 connect with the network switch 180 and build physical networks. The network-attached storage devices 130˜140 use the network interfaces 170 to connect with the network switch 180. Namely, the network switch 180 facilitates communication between the compute nodes 110˜120 and the network-attached storage device 130˜140.

In the clustering system shown in FIG. 1, the actual physical partition may configure the system I/O buses 150, the NICs 162˜164, and the network interfaces 170 on a bottom plane 190. Since the NICs 162˜164 are independent from the compute nodes 110˜120, i.e. the NICs 162˜164 are not located on the compute node 110/120, the system I/O bus 150 is an essential interface to connect the compute node 110/120 and the NIC 162/164. Then, apparently the physical signal interface (system I/O bus plus network interface) between the compute node 110/120 and the network switch 180 are different from the one (network interface only) between the storage device 130/140 and the network switch 180. That means the clustering system needs to have at least two types of connection slots with different functions on the bottom plane 190. And these physical connection slots cannot be shared between one compute node and one storage device. In FIG. 1, the connection slots 111˜121 cannot be used to connect the storage devices 130˜140. In the other hand, the connection slots 131˜141 cannot be used to connect with the compute node 110/120 either.

### SUMMARY OF THE INVENTION

The problems noted above are solved in large part by the present invention that provides a slot for different types of functions, such as computation and storage, thereby facilitating a flexible system configuration that allows selecting different network technologies.

According to an exemplary embodiment of the invention, an interconnection architecture is provided for flexibly connecting a primary host module or an added host module to a network switch in a clustering system. The interconnection architecture mainly includes plural first slots, a primary function module, an added function module, and plural multifunctional buses. The first slots electrically connect the network switch with the primary host module and the added host module. The primary function module inserts in one of the first slots to electrically connect the primary host module with the network switch; and the added function module inserts in one of the first slots to electrically connect the added host module with the network switch. The multifunctional buses connect the network switch with the first slots and also connect the first slots with the primary host module and the added host module.

In accordance with another exemplary embodiment of the invention, a clustering system is provided for flexibly connection. The clustering system includes a network switch, at least one primary host module and/or at least one added host module, plural first slots, a primary function module, an added function module, and plural multifunctional buses. The first slots electrically connect the network switch with the primary host module and the added host module. The primary function module inserts in one of the first slots to electrically connect the primary host module with the network switch; and the added function module inserts in one of the first slots to electrically connect the added host module with the network switch. The multifunctional buses connect the network switch with the first slots and also connect the first slots with the primary host module and the added host module.

According to another exemplary embodiment of the invention, the primary host module is a compute node. The added host module may be a storage node. The multifunctional buses may have one section protocol-compatible with system Input/Output bus and another section physical-compatible with physical network.

In accordance with another exemplary embodiment of the invention, the primary function module is a network interface controller module embedded with a network interface controller. Besides, the added function module is a passive through module to directly connect the multifunctional buses from the network switch and from the primary and/or added host module.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is an explanatory block diagram for the interconnection architecture of a clustering system in the prior art.

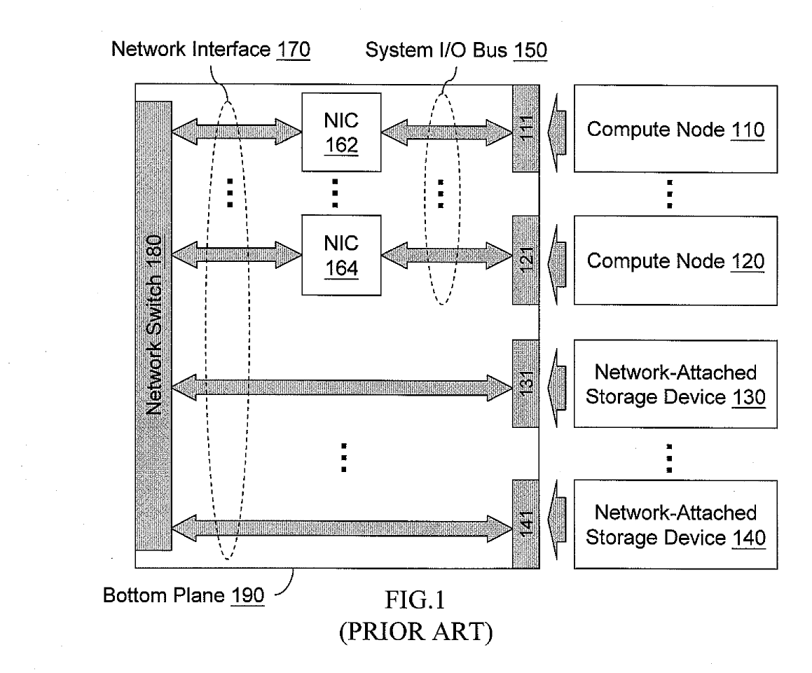

FIG. 2 is an explanatory block diagram for a flexible interconnection architecture according to an embodiment of the invention.

FIG. 3 is another explanatory block diagram for the flexible interconnection architecture according to another embodiment of the invention.

FIG. 4 is another explanatory block diagram for the flexible interconnection architecture according to another embodiment of the invention.

### DETAILED DESCRIPTION OF THE INVENTION

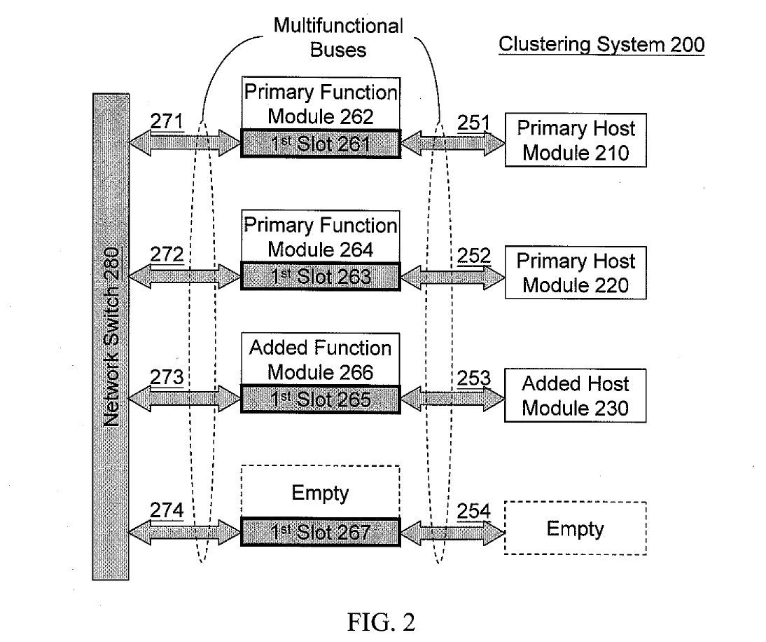

Please refer to FIG. 2. A flexible interconnection architecture for a clustering system 200 mainly includes one or more primary host modules 210/220, one or more added host modules 230, one or more first slots 261/263/265/267, one or more primary function modules 262/264, one or more added function modules 266, multifunctional buses 251/252/253/254, 271/272/273/274, and network switch 280.

Each primary host module 210/220 is basically a computer host with operating system in an operating system domain, such as a head node or compute node in a common clustering system. The added host module 230 provides network attached resources (such as storage spaces) that can be used by the primary host module 210/220 through the network switch 280.

Each primary function module 262/264 is to provide an interface, such as a NIC (Network Interface Controller) for the primary host module 210/220 to electrically connect with the network switch 280. Similarly, the added function module 266 is also to provide an interface for the added host module 230 to electrically connect with the network switch 280. Both the primary function modules 262/264 and the added function module 266 may be connected to the multifunctional bus 251/252/253/254, 271/272/273/274 by inserting the primary function module 262/264 into the first slot 261/263/265/267.

Each first slot 261/263/265/267 is basically an on-board connector that includes plural electrical pins to facilitate communication between each primary function module 262/264 and the multifunctional buses 251/252,271/272 or between the added function module 266 and the multifunctional buses 253, 273.

Each multifunctional bus 251/252/253/254 may be used as a system I/O bus. Meanwhile, each multifunctional bus 271/272/273/274 may be used as physical network. In the present invention, the multifunction buses 251/252/253/254 and 271/272/273/274 are the same type interface that has similar characteristics, such as SerDes (Serializer/Deserializer) interface. As a concrete example, PCI Express and InfiniBand are used for similar electrical requirement, and the same physical connection can be used for the both interface. An interface based on system I/O bus will be more suitable to replace the physical network connection. Generally, system I/O bus supports more functions than a physical network does. Therefore, each multifunctional bus can possibly be realized by some specific interfaces that are substantially system I/O buses, such as SerDes interfaces.

With the interconnection architecture disclosed above, each first slot 261/263 can be connected with each primary function module 262/264 respectively when each first slot 261/263/265/267 is also connected to the corresponding primary host module 210/220. Similarly, if the added function module 266 is inserted in one of the first slot 267, and then other first slots 261/263/265 may be connected with the added host module 230. In FIG. 2, the first slot 267 may allow another primary function module (not shown) or another added function module (not shown) inserting therein so that the first slot 267 may be connected correspondingly with another primary host module or another added host module.

The actual physical partitioning of the clustering system 200 would be implementation dependent. Sometime the first slot(s) can be located on the same physical partitioning with a compute node (the primary host module). Sometime the first slot(s) can be located on the same partitioning as the network switch, such as on a network switchboard. Sometime it can be the same as an interconnection board. Anyways, the logical or functional connection is basically the same in the clustering system 200.

If a compute node (such as the primary host module) and a network interface (such as the primary function module) controller are located on the same physical partitioning, the interface to the network switch is a network technology, such as Gigabit Ethernet, InfiniBand, 10 Gigabit Ethernet and etc.

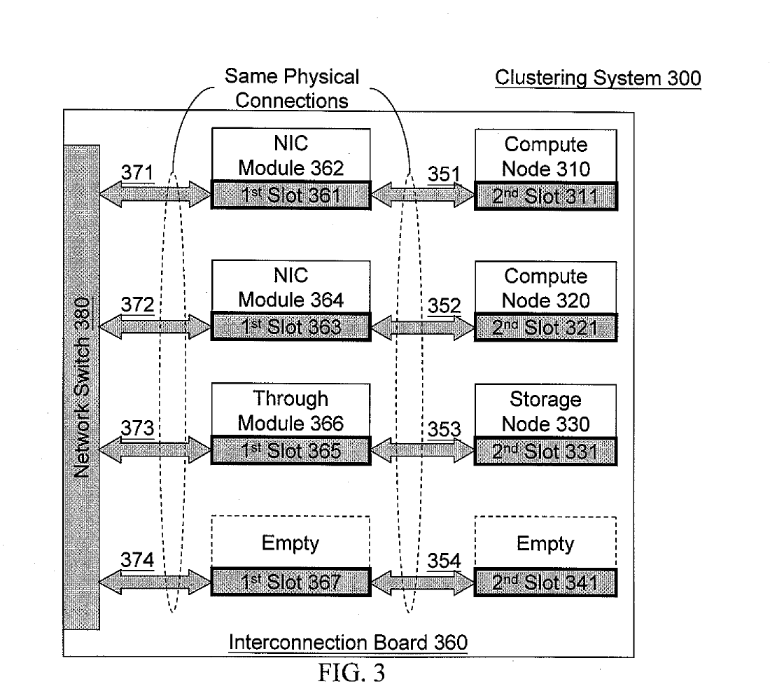

FIG. 3 shows an example of the physical partitioning for a flexible interconnection architecture of a clustering system according to the present invention. This implementation allows the clustering system to choose a flexible network technology as well as flexible slot function selection based on a target application.

The interconnection architecture of clustering system 300, as shown in FIG. 3, is mainly configured or attached onto an interconnection board 360. The interconnection board 360 usually supports multiple functions with different slots, such as computation slots (such as second slots 311/321), I/O slots (not shown), storage slot(s) (such as a second slot 331) and etc. This interconnection board 360 mainly provides system I/O bus interconnection, such as PCI Express and etc. The interconnection board 360 comprises connector interfaces (such as first slots 371/372 and second slots 311/321/331/341) for compute node 310/320s, storage node 330, and other function of module(s). The signal interface to all the modules comprises common signal block(s) and function specific signal block(s).

One or more compute nodes 310/320 are inserted in second slot 311/321 configured on the interconnection board 360. One or more NIC (Network Interface Controller) modules 362/364 embedded with a network interface controller (not shown) are inserted in one or more first slots 361/363, respectively. Therefore, the compute node 310, for example, is able to connect with the network switch 380 through the NIC module 362, for example.

A network-attached storage node 330 having one or more hard disks (not shown) are inserted in a second slot 331. Since the connection between the storage node 330 and the network switch 380 should be a physical network interface, a through module 366 is inserted in the first slot 365 to directly connect the SerDes-based physical connection 353 and 373.

The first slot 367 and the second slot 341, for example, may be empty and to be inserted with another through module (not shown) and another storage node (not shown) correspondingly. Meanwhile, the first slot 367 and the second slot 341 may also be inserted with another NIC module and another compute node correspondingly. If the first and the second slots are used for the compute node, the physical connection will act as a system I/O bus, and the NIC module will be used to provide a physical network connection for the compute nodes. The compute nodes 310, 320, 330 will be connected through the network switch 380 to communicate with other compute nodes as well as storage nodes in the clustering system.

If the first and second slots are used for the storage node, the through module will be inserted into the first slot and provides passive connection between the system-I/O-bus-side and the physical-network-side SerDes-based physical connection. Namely, the connection between the through module and the storage node will act like a physical network interface uses the same connection and operates as a system I/O bus.

Except the multifunctional first and the second slots, all the connection between the first slots 361,363,365,367 and the second slots 311,321, 331,341 are the same type of interface, namely using the Ser/Des-based physical connections. The system-I/O-bus-side (e.g. the connection 351/352/353/354) and the physical-network-side (e.g. the connection 371/372/373/374) of SerDes-based physical connections have similar number of signal wires. Alternatively, the signal wires of the system-I/O-bus-side (e.g. the connection 351/352/353/354) of SerDes-based physical connection are more than the signal wires of the physical-network-side (e.g. the connection 371/372/373/374) of SerDes-based physical connections. In a typical case, the system I/O bus requires a similar or more bandwidth than a network interface.

For actual implementation, interface between the network interface controller and network switch, namely the SerDes-based physical connection 371/372/373/374 needs to be AC coupled interface. This allows more flexibility to share the same interconnection with different network interface, such as different bias voltage requirement for each side.

There could be still required some function specific signals. Even if multiple functions are applicable to the same first or second slots, it is possible to assign some custom signals for each function. Besides, the way of using the SerDes-based physical connections in the embodiment is basically using a system I/O bus as a primary system interconnection instead of a physical network interface. Since a system I/O bus can support more functions than a physical network interface, more flexible ways are allowed to configure the clustering system.

One example implementation is described as follows:
Select PCI Express bus as a system I/O bus interface with its physical layer using SerDes interface. For example, the multifunctional buses 251˜254 in FIG. 2 and the physical connection 351˜354 in FIG. 3 are protocol-compatible with PCI Express and physical-compatible with SerDes interface.
Select Gigabit Ethernet and/or InfiniBand as physical network interface with its physical layer using SerDes interface. For example, the multifunctional buses 271˜274 in FIG. 2 and the physical connection 371˜374 in FIG. 3 are protocol-compatible with a physical network (such as the Gigabit Ethernet and/or InfiniBand) and physical-compatible with SerDes interface.
Although Gigabit Ethernet and InfiniBand follow different physical layer implementations and different protocols, a similar physical layout rule can be applied. With AC coupled interface, a NIC module and a network switch can used with different bias voltages on each side.
Electrical characteristics for PCI Express/InfiniBand/Gigabit Ethernet are similar enough to use a passive “through module” for connection in-between.
A clustering system according to the present invention will be capable of supporting InfiniBand and Gigabit Ethernet model for a physical network by using different NIC modules and network switch.

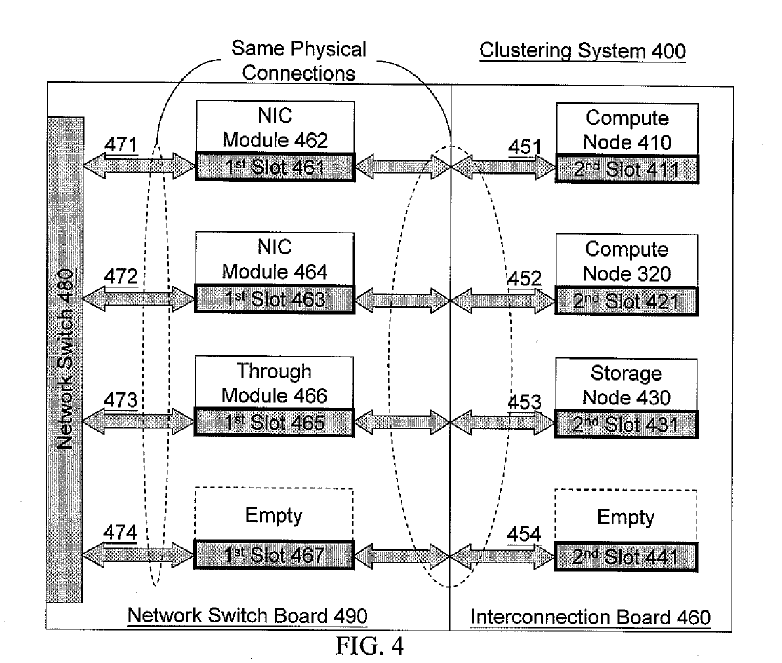

FIG. 4 shows another physical partitioning for another interconnection architecture of a clustering system 400. The network-related first slots 461˜467 and the network switch 480, and the connected NIC module 462/464 or through module 466 are integrated on a network switch board 490. The second slots 411/421/431/441 and connected compute nodes 410/420 or storage node 430 remain on the interconnection board 460. Though the same physical connections 451˜454, 471˜474 are separated on network switch board 490 and interconnection board 460 (also the physical connections 451˜454 are divided into two sections; one section on the network switch board 490, the other on the interconnection board 60), the logical connection is still the same.

In short, the advantages of the present invention are further explained in the following.

First of all, the present invention can share the same second slots (as shown in FIG. 2) with multiple functions, such as connecting a compute host or a storage node, by using different type of function modules (such as the NIC module or the through module) in the first slots.

Besides, the present invention basically changes the usage of network technology. And it also changes the basic system architecture between the compute nodes, the interconnection board, and the network switch. In the prior art, the designs of the interconnection board and the compute nodes are complicated. Therefore, sharing the same complicated parts of design is absolutely a great advantage. Replacing the NIC/through modules and the network switch will be the only change for different implementation. Different designs for changing NIC module and network switch are relatively easy.

In addition, since the connection between the host module and the function module is based on a system I/O bus, the whole network switch board can be replaced with other I/O function, such as graphics, storage interface and etc. That improves the clustering system with more flex extension capability.

Moreover, since the same slots can be used for multiple functions, the number of modules for each function is very flexible. Therefore, the clustering system can be configured optimized according to the actual target application. If a clustering system requires more compute nodes, the user may reduce the storage nodes.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An interconnection architecture for flexibly connecting at least one primary host module and/or at least one added host module to a network switch in a clustering system, the interconnection architecture comprising:
a plurality of first slots electrically connecting the network switch with the primary host module and/or connecting the network switch with the added host module;
at least one primary function module inserting in at least one of the first slots to electrically connect the primary host module with the network switch, and/or at least one added function module inserting in at least one of the first slots to electrically connect the added host module with the network switch; and
a plurality of multifunctional buses connecting the network switch with the first slots and connecting the first slots with the primary host module and/or the added host module.

2. The interconnection architecture of claim 1, wherein the primary host module is a compute node.

3. The interconnection architecture of claim 1, wherein the added host module is a storage node.

4. The interconnection architecture of claim 1, wherein the multifunctional bus between the network switch and the connected first slot is protocol-compatible with physical network of the clustering system.

5. The interconnection architecture of claim 1, wherein the multifunctional bus between the primary host module and the connected first slot and/or between the added host module and the first slot is protocol-compatible with system Input/Output bus of the clustering system.

6. The interconnection architecture of claim 1, wherein the primary function module is a network interface controller module embedded with a network interface controller.

7. The interconnection architecture of claim 1, wherein the added function module is a passive through module for directly connecting the multifunctional buses from the network switch and the primary host module and/or from the network switch and the added host module.

8. The interconnection architecture of claim 1, wherein each of the multifunctional buses is physical-compatible with SerDes interface.

9. The interconnection architecture of claim 1, wherein the multifunctional bus between the primary host module and the connected first slot and/or between the added host module and the connected first slot is protocol-compatible with PCI Express.

10. The interconnection architecture of claim 1, wherein the multifunctional bus between the network switch and the connected first slot is protocol-compatible with Ethernet or InfiniBand.

11. A clustering system comprising:
a network switch;
at least one primary host module and/or at least one added host module;
a plurality of first slots electrically connecting the network switch with the primary host module and/or connecting the network switch with the added host module;
at least one primary function module inserting in at least one of the first slots to electrically connect the primary host module with the network switch, and/or at least one added function module inserting in at least one of the first slots to electrically connect the added host module with the network switch; and
a plurality of multifunctional buses connecting the network switch with the first slots and connecting the first slots with the primary host module and/or the added host module.

12. The clustering system of claim 11, wherein the primary host module is a compute node.

13. The clustering system of claim 11, wherein the added host module is a storage node.

14. The clustering system of claim 11, wherein the multifunctional bus between the network switch and the connected first slot is protocol-compatible with physical network of the clustering system.

15. The clustering system of claim 11, wherein the multifunctional bus between the primary host module and the connected first slot and/or between the added host module and the connected first slot is protocol-compatible with system Input/Output bus.

16. The clustering system of claim 11, wherein the primary function module is a network interface controller module embedded with a network interface controller.

17. The clustering system of claim 11, wherein the added function module is a passive through module for directly connecting the multifunctional buses from the network switch and the primary host module and/or from the network switch and the added host module.

18. The clustering system of claim 11 further comprising a plurality of second slots for inserting the primary host module and/or the added host module therein, the second slots connecting with the first slots through the multifunctional buses.

19. The clustering system of claim 11, wherein each of the multifunctional buses is physical-compatible with SerDes interface.

20. The clustering system of claim 11, wherein the multifunctional bus between the primary host module and the connected first slot is protocol-compatible with PCI Express, and/or the multifunctional bus between the network switch and the connected first slot is protocol-compatible with Ethernet or InfiniBand.
